(19) United States
(12) Patent Application Publication
(10) Pub. No.: US 2016/0189610 A1
(43) Pub. Date: Jun. 30, 2016

(54) DISPLAY DEVICE, PIXEL DRIVING CIRCUIT AND DRIVING METHOD THEROF

(71) Applicant: EverDisplay Optronics (Shanghai) Limited, Shanghai City (CN)

(72) Inventors: Lina XIAO, Shanghai City (CN); Zhaobin YANG, Shanghai City (CN); Jie NI, Shanghai City (CN)

(21) Appl. No.: 14/852,703

(22) Filed: Sep. 14, 2015

(30) Foreign Application Priority Data
Dec. 29, 2014 (CN) 201410848357.5

(51) Int. Cl. G09G 3/32

(52) U.S. Cl. CPC G09G 3/3233; G09G 3/3258; G09G 2300/0809; G09G 2320/0233

(57) ABSTRACT

There provides a display device, a pixel driving circuit and a driving method thereof. The pixel driving circuit includes an organic light emitting diode, a first, a second and a third switching transistor, a storage capacitor, a driving transistor, a compensation unit and a reset unit. The first switching transistor writes a data signal into the storage capacitor via the driving transistor and the compensation unit; the second switching transistor applies a driving voltage to the driving transistor; the third switching transistor applies a driving current output from the driving transistor to the organic light emitting diode; the compensation unit writes a threshold voltage of the driving transistor into the storage capacitor; the storage capacitor stores a written voltage signal and apply it to the driving transistor; and the reset unit resets the organic light emitting diode and the storage capacitor.

### CROSS REFERENCE TO RELATED DISCLOSURES

The present application claims priority under 35 U.S.C. §119 to Chinese Patent Application No. 201410848357.5, filed on Dec. 29, 2014, the entire content of which are incorporated herein by reference.

### TECHNICAL FIELD

The present disclosure generally relates to the field of display technology, particularly to a pixel driving circuit, a driving method of the pixel driving circuit and a display device including the pixel driving circuit.

### BACKGROUND

Compared with LCD (Liquid Crystal Display) panels in the conventional technology, OLED (Organic Light Emitting Diode) display panels have advantages of faster response, better color purity and brightness, higher contrast, wider view angle, etc. Therefore, OLED display panels are gaining increasingly widespread attention from developers for the display technology.

A pixel unit in an OLED display panel mainly includes an organic light emitting diode and a pixel unit driving circuit for driving the organic light emitting diode. A conventional 2T1C pixel unit driving circuit is as illustrated in FIG. 1: it includes a first switching transistor T1, a driving transistor DTFT and a storage capacitor Cst. Wherein the first switching transistor T1 is controlled by a first scan signal Sn output by a scan line (Scan Line), for controlling the writing of a data signal Data from a data line (Data Line). The driving transistor DTFT is configured to control the organic light emitting diode OLED to emit light, and the storage capacitor Cst is configured to provide a sustaining voltage for a gate of the driving transistor DTFT.

The organic light emitting diode OLED can emit light, which is driven by a driving current generated by the driving transistor DTFT operating in a saturation state. Wherein the driving current I_{OLED} can be expressed as:

$${I}_{OLED} = \frac{1}{2} {μ}_{n} \cdot {C}_{OX} \cdot \frac{W}{L} \cdot {( ELVDD - Vdata - Vth )}^{2}$$

Wherein μₙ·C_{OX}·W/L is a constant relevant to a production process and design, for example, μₙ is a carrier mobility, C_{OX} is a capacitance of a gate oxide layer, W/L is a width-to-length ratio of the transistor, Vdata is a voltage of the data signal Data, ELVDD is a driving voltage for driving the transistor DTFT, which is shared by all the pixel units, and Vth is a threshold voltage of the driving transistor DTFT.

However, due to technical limitations, the uniformity of the threshold voltage Vth is usually poor, and drift of the threshold voltage Vth may also occur in practical usage. From the above equation, if Vthes are different among different pixel units, differences will occur in the driving currents, which may result in non-uniform brightness. If the threshold voltage Vthes of the driving transistors drift over time, the currents may change from time to time, which may influence the displaying effect.

### SUMMARY

An object of the present disclosure is to provide a pixel driving circuit, a driving method of the pixel driving circuit and a display device including the pixel driving circuit, to overcome, at least to a certain degree, one or more problems due to the technical limitations and disadvantages in the related art.

Other features and advantages of the present disclosure will be apparent from the following detailed description, or partially learned through practice of the present disclosure.

According to a first aspect of embodiments of the present disclosure, there provides a pixel driving circuit, including an organic light emitting diode, a first, a second and a third switching transistor, a storage capacitor, a driving transistor, a compensation unit and a reset unit, wherein:

the first switching transistor is configured to write a data signal into the storage capacitor via the driving transistor and the compensation unit in response to a first scan signal;

the second switching transistor is configured to apply a driving voltage to the driving transistor in response to a light emitting control signal;

the third switching transistor is configured to apply a driving current output from the driving transistor to the organic light emitting diode to cause it to emit light, in response to the light emitting control signal;

the compensation unit is configured to write a threshold voltage of the driving transistor into the storage capacitor in response to an enable signal;

the storage capacitor is configured to store the written data signal and the threshold voltage and apply the written data signal and the threshold voltage to a gate of the driving transistor; and

the reset unit is configured to reset the organic light emitting diode and the storage capacitor with an initial voltage, in response to a reset signal.

In an exemplary embodiment of the present disclosure,

a gate of the first switching transistor receives the first scan signal, a source thereof receives the data signal, and a drain thereof is connected to a source of the driving transistor;

a gate of the second switching transistor receives the light emitting control signal, a source thereof is connected to the driving voltage, and a drain thereof is connected to a source of the driving transistor;

a gate of the third switching transistor receives the light emitting control signal, a source thereof is connected to a drain of the driving transistor, and a drain thereof is connected to a first terminal of the organic light emitting diode;

a first terminal of the compensation unit is connected to the drain of the driving transistor, a second terminal thereof is connected to the storage capacitor, and a control terminal thereof receives the enable signal;

a first terminal of the storage capacitor is connected to the gate of the driving transistor, and a second terminal thereof is connected to the driving voltage; and

a first terminal of the reset unit is connected to the initial voltage, a second terminal thereof is connected to the first terminal of the organic light emitting diode, a third terminal thereof is connected with the first terminal of the compensation unit, and a control terminal thereof receives the reset signal.

In an exemplary embodiment of the present disclosure,

the reset unit includes a first reset transistor and a second reset transistor;

a gate of the first reset transistor receives the reset signal, a source thereof is connected to the initial voltage, and a drain thereof is connected to a source the second reset transistor and the first terminal of the organic light emitting diode; and

a gate of the second reset transistor receives the reset signal, and a drain thereof is connected to the first terminal of the compensation unit.

In an exemplary embodiment of the present disclosure,

the compensation unit includes a first compensation transistor and a second compensation transistor;

a gate of the first compensation transistor receives the enable signal, a source thereof is connected to the drain of the driving transistor, and a drain thereof is connected to a source of the second compensation transistor; and

a gate of the second compensation transistor receives the enable signal, and a drain thereof is connected to the first terminal of the storage capacitor.

In an exemplary embodiment of the present disclosure,

the reset signal is a second scan signal;

the first scan signal is provided by a scan line; and

the second scan signal is provided by a previous scan line to the scan line.

In an exemplary embodiment of the present disclosure,

all of the transistors are P type thin film transistors;

the driving voltage connected to the source of the second switching transistor is a high level driving voltage;

the drain of the third switching transistor is connected to an anode of the organic light emitting diode; and

a cathode of the organic light emitting diode is connected to a low level voltage.

In an exemplary embodiment of the present disclosure,

all of the transistors is an N type thin film transistor;

the driving voltage connected to the source of the second switching transistor is a low level driving voltage;

the drain of the third switching transistor is connected to a cathode of the organic light emitting diode; and

an anode of the organic light emitting diode is connected to a high level voltage.

According a second aspect of the present disclosure, there provides a driving method of a pixel driving circuit, wherein the pixel driving circuit is any one of pixel driving circuits according to the first aspect of the present disclosure, and the driving method includes:

turning on the compensation unit and the reset unit respectively by using the enable signal and the reset signal, thereby causing the initial voltage to reset the organic light emitting diode via the reset unit and to reset the storage capacitor via the reset unit and the compensation unit respectively;

turning on the first switching transistor and the compensation unit respectively by using the first scan signal and the enable signal, thereby causing the data signal and the threshold voltage to be written into the storage capacitor; and

turning on the second and the third switching transistor by using the light emitting control signal, thereby turning on the driving transistor by using the data signal and the threshold voltage written into the storage capacitor, and causing the driving voltage drive to drive the organic light emitting diode to emit light via the second and the third switching transistor and the driving transistor.

According a third aspect of the present disclosure, there provides a display device, including:

a plurality of data lines for providing data signals;

a plurality of scan lines for supplying scan signals, wherein the scan signals include a first scan signal and a second scan signal which are provided successively; and

a plurality of pixel driving circuits, electrically connected to the data lines and the scan lines, each of the plurality of pixel driving circuit includes an organic light emitting diode, a first, a second and a third switching transistor, a storage capacitor, a driving transistor, a compensation unit and a reset unit, wherein:

the first switching transistor is configured to write one of the data signals into the storage capacitor via the driving transistor and the compensation unit in response to the first scan signal;

the second switching transistor is configured to apply a driving voltage to the driving transistor in response to a light emitting control signal;

the third switching transistor is configured to apply a driving current output from the driving transistor to the organic light emitting diode to cause it to emit light, in response to the light emitting control signal;

the compensation unit is configured to write a threshold voltage of the driving transistor into the storage capacitor in response to an enable signal;

the storage capacitor is configured to store the written one data signal and the threshold voltage and apply the written one data signal and the threshold voltage to a gate of the driving transistor; and

the reset unit is configured to reset the organic light emitting diode and the storage capacitor with an initial voltage, in response to a reset signal.

In an exemplary embodiment of the present disclosure,

a gate of the first switching transistor receives the first scan signal, a source thereof receives the one data signal, and a drain thereof is connected to a source of the driving transistor;

a gate of the second switching transistor receives the light emitting control signal, a source thereof is connected to the driving voltage, and a drain thereof is connected to a source of the driving transistor;

a gate of the third switching transistor receives the light emitting control signal, a source thereof is connected to a drain of the driving transistor, and a drain thereof is connected to a first terminal of the organic light emitting diode;

a first terminal of the compensation unit is connected to the drain of the driving transistor, a second terminal thereof is connected to the storage capacitor, and a control terminal thereof receives the enable signal;

a first terminal of the storage capacitor is connected to the gate of the driving transistor, and a second terminal thereof is connected to the driving voltage; and

a first terminal of the reset unit is connected to the initial voltage, a second terminal thereof is connected to the first terminal of the organic light emitting diode, a third terminal thereof is connected with the first terminal of the compensation unit, and a control terminal thereof receives the reset signal.

In an exemplary embodiment of the present disclosure,

the reset unit includes a first reset transistor and a second reset transistor;

a gate of the first reset transistor receives the reset signal, a source thereof is connected to the initial voltage, and a drain thereof is connected to a source the second reset transistor and the first terminal of the organic light emitting diode; and

a gate of the second reset transistor receives the reset signal, and a drain thereof is connected to the first terminal of the compensation unit.

In an exemplary embodiment of the present disclosure,

the compensation unit includes a first compensation transistor and a second compensation transistor;

a gate of the first compensation transistor receives the enable signal, a source thereof is connected to the drain of the driving transistor, and a drain thereof is connected to a source of the second compensation transistor; and

a gate of the second compensation transistor receives the enable signal, and a drain thereof is connected to the first terminal of the storage capacitor.

In an exemplary embodiment of the present disclosure,

the reset signal is the second scan signal;

the first scan signal is provided by one scan line of the plurality of scan lines;

and

the second scan signal is provided by a previous scan line to the one scan line.

In an exemplary embodiment of the present disclosure,

all of the transistors are P type thin film transistors;

the driving voltage connected to the source of the second switching transistor is a high level driving voltage;

the drain of the third switching transistor is connected to an anode of the organic light emitting diode; and

a cathode of the organic light emitting diode is connected to a low level voltage.

In an exemplary embodiment of the present disclosure,

all of the transistors is an N type thin film transistor;

the driving voltage connected to the source of the second switching transistor is a low level driving voltage;

the drain of the third switching transistor is connected to a cathode of the organic light emitting diode; and

an anode of the organic light emitting diode is connected to a high level voltage.

In the pixel driving circuits provided by exemplary embodiments of the present disclosure, firstly, the level of the gate of the driving transistor is reset via the preset unit, thereby to eliminate the influence of the residual voltage signal of the previous frame; then, the threshold voltage and the data signal of the driving transistor are pre-stored in the storage capacitor via the compensation unit during the process that data is written into the storage capacitor, thereby to effectively compensate for the drift of the threshold voltage. In this way, the uniformity and stability of the driving currents may be ensured, and thus the brightness of the OLED display panel may be made more uniform.

### BRIEF DESCRIPTION OF THE DRAWINGS

By referring to the exemplary embodiments thereof described in detail with the accompanying drawings, the above and other features and advantages of the present disclosure will become more apparent.

FIG. 1 is a schematic diagram of a pixel driving circuit in the related art;

FIG. 2 is a schematic diagram of connection of modules in a pixel driving circuit according to an exemplary embodiment of the present disclosure;

FIG. 3 is a schematic diagram of a pixel driving circuit according to an exemplary embodiment of the present disclosure;

FIG. 4 is a timing sequence diagram of the pixel driving circuit illustrated in FIG. 3;

FIGS. 5 to 7 are diagrams of equivalent circuits in a reset stage of the pixel driving circuit illustrated in FIG. 3;

FIGS. 8 to 9 are diagrams of equivalent circuits in a charging stage of the pixel driving circuit illustrated in FIG. 3;

FIGS. 10 to 12 are diagrams of equivalent circuits in a displaying stage of the pixel driving circuit illustrated in FIG. 3; and

FIG. 13 is a schematic diagram of a simulation result of leakage of a storage capacitor of the pixel driving circuit according to the exemplary embodiment.

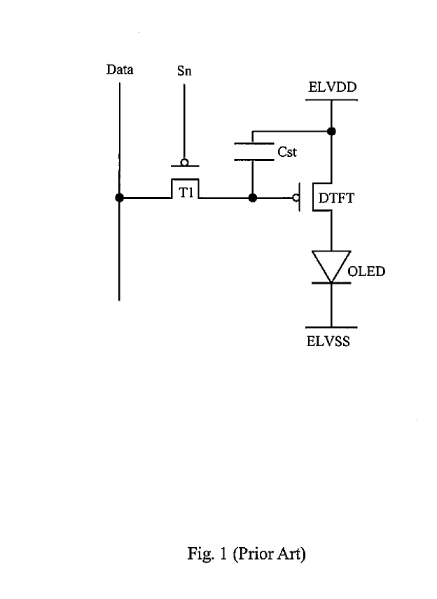

Reference numerals are defined as follows:
11, T1 first switching transistor
12, T2 second switching transistor
13, T3 third switching transistor
14 compensation unit
T4 first compensation transistor
T5 second compensation transistor
15 reset unit
T6 first reset transistor
T7 second reset transistor
16, Cst storage capacitor
OLED organic light emitting diode
DTFT driver transistor
ELVDD driving voltage
ELVSS low level voltage
Data data signal
Sn first scan signal
Sn−1 second scan signal
Sn′ enable signal
En light emitting control signal
Vint initial voltage

### DETAILED DESCRIPTION

Now exemplary embodiments will be described more fully with reference to the accompanying drawings. However, the exemplary embodiments may be embodied in various forms, and should not be construed as limited to the embodiments set forth herein. Rather, these embodiments are provided so that this disclosure will be thorough and complete, and fully convey the concept of the exemplary embodiments to those skilled in the art. In the drawings, the same reference numerals denote the same or similar structure, and therefore a detailed description thereof will be omitted.

Moreover, the described features, structures or characteristics may be combined in any suitable manner in one or more embodiments. In the following description, numerous specific details are provided in order that the embodiments of the present disclosure could be fully understood. However, those skilled in the art will recognize that the solution of the present disclosure may be practiced without one or more of the specific details, or may take other methods, devices, connections and the like. In these cases, known structures, methods or operations are not shown or described in detail to avoid obscuring aspects of the present disclosure.

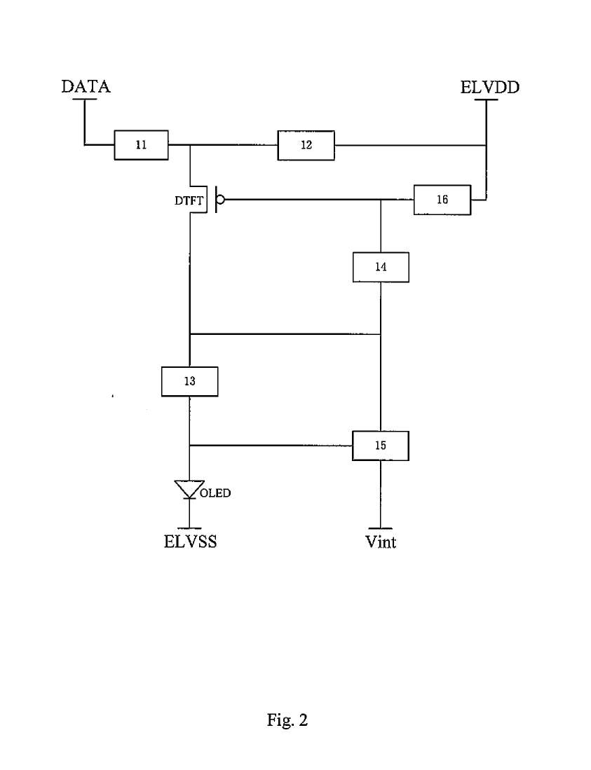

In the present exemplary embodiment, firstly, there provides a pixel driving circuit. As illustrated in FIG. 2, the pixel driving circuit mainly includes an organic light emitting diode OLED, a first switching transistor 11, a second switching transistor 12, a third switching transistor 13, a compensation unit 14, a reset unit 15, a storage capacitor 16 and a driving transistor DTFT, etc.

Wherein a first terminal of the first switching transistor 11 is connected to a data line, to receive a data signal Data, and a second terminal thereof is connected to a source of the driving transistor DTFT, to write the data signal Data into the storage capacitor 16 via the driving transistor DTFT and the compensation unit 14 in response to a first scan signal. A first terminal of the second switching transistor 12 is connected to a driving voltage, and a second terminal thereof is connected to the source of the driving transistor DTFT, to apply the driving voltage to the source of the driving transistor DTFT in response to a light emitting control signal. A first terminal of the third switching transistor 13 is connected to a drain of the driving transistor DTFT, and a second terminal thereof is connected to a first terminal of the organic light emitting diode OLED, to apply a driving current output from the drain of the driving transistor DTFT to the light emitting diode OLED to cause it to emit light, in response to the light emitting control signal. A first end of the compensation unit 14 is connected to the drain of the driving transistor DTFT, and a second terminal thereof is connected to a first terminal of the storage capacitor 16, to pre-store a threshold voltage of the driving transistor DTFT to the storage capacitor 16. The first terminal of the storage capacitor 16 is connected to a gate of the driving transistor DTFT, and a second terminal thereof is connected to the driving voltage. The storage capacitor 16 is configured to store a written voltage signal, and provide it to the gate of the driving transistor DTFT. A first terminal of the reset unit 15 is connected to an initial signal, a second terminal thereof is connected to the second terminal of the third switching transistor 13, and a third terminal thereof is connected to the first terminal of the compensation unit 14, to reset the organic light emitting diode OLED in response to a reset signal and write an initial voltage Vint into the storage capacitor 16 via the compensation unit 14 to reset the storage capacitor 16, so as to eliminate the influence of the residual voltage signal of the previous frame in the storage capacitor 16.

Hereinafter, the driving method of the pixel driving circuit is briefly described. The method may include the following steps.

In a reset stage: the reset unit 15 and the compensation unit 14 are turned on, and the first to the third switching transistors 11-13 are turned off, by using the first scan signal, the light emitting control signal, an enable signal and the reset signal. The initial voltage Vint resets the organic light emitting diode OLED via the reset unit 15, and the initial voltage Vint is written into the storage capacitor 16 via the reset unit 15 and the compensation unit 14 to reset the storage capacitor 16, so as to eliminate the influence of the residual voltage signal of the previous frame.

In a charging stage: the first switching transistor 11 and the compensation unit 14 are turned on, and the second and the third switching transistors 12-13 and the reset unit 15 are turned off, by using the first scan signal, the light emitting control signal, the enable signal and the reset signal. The data signal Data and the threshold voltage of the driving transistor DTFT are written into the storage capacitor 16.

In a displaying stage: the second and the third switching transistors 12-13 are turned on, and the first switching transistor 11, the compensation unit 14 and the reset unit 15 are turned off, by using the first scan signal, the light emitting control signal, the enable signal and the reset signal. The driving transistor DTFT is turned on by using the voltage signal stored in the storage capacitor 16, to drive the organic light emitting diode OLED to emit light.

In the above pixel driving circuit, firstly the reset unit 15 resets the level of the gate of the driving transistor DTFT, and writes the initial voltage Vint into the storage capacitor 16 to reset the storage capacitor 16, thereby the influence of the previous frame of voltage signal is eliminated. Then, the compensation unit 14 pre-stores the threshold voltage of the driving transistor DTFT and the data signal Data to the storage capacitor 16 when data is written to the storage capacitor 16, thereby the drift of the threshold voltage may be effectively compensated, and the uniformity and stability of the driving currents may be ensured, and thus the brightness of the OLED display panel may be made more uniform.

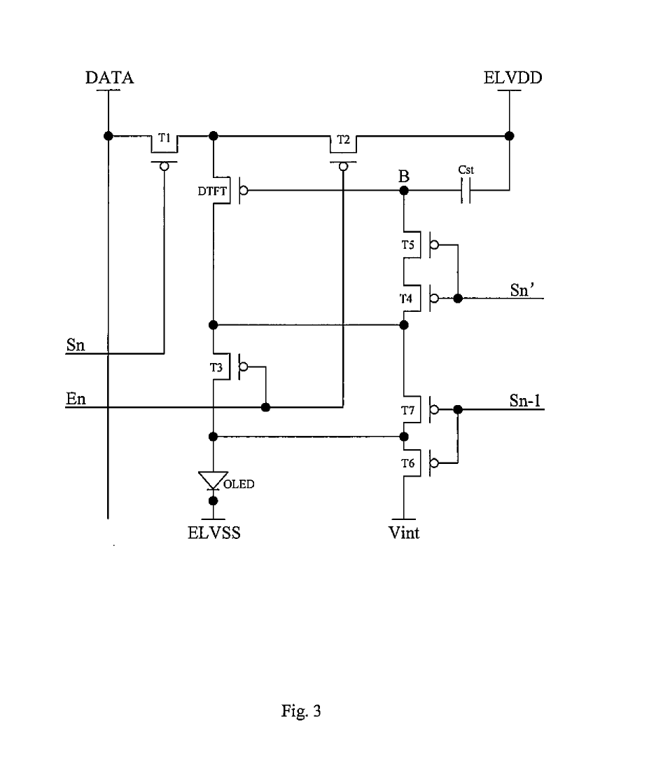

As illustrated in FIG. 3, it shows a specific implementation of the above pixel driving circuit. Wherein the compensation unit may include a first compensation transistor T4 and a second compensation transistor T5. The reset unit may include a first reset transistor T6 and a second reset transistor T7. A gate of the first switching transistor T1 is connected to a first scan line, a source thereof receives the data signal Data, and a drain thereof is connected to the source of the driving transistor DTFT. The first switching transistor T1 may be turned on or off under a control of a first scan signal Sn output from the first scan line. A gate of the second switching transistor T2 receives a light emitting control signal En, a source thereof is connected to the driving voltage, and a drain thereof is connected to the source of the driving transistor DTFT. A gate of the third switching transistor T3 receives the light emitting control signal En, a source thereof is connected to the drain of the driving transistor DTFT, and a drain thereof is connected to the first terminal of the organic light emitting diode OLED. The second switching transistor T2 and the third switching transistor T3 may be turned on or off under a control of the light emitting control signal En. A gate of the first compensation transistor T4 receives an enable signal Sn′, a source thereof is connected to the drain of the driving transistor DTFT, and a drain thereof is connected to a source of the second compensation transistor T5. A gate of the second compensation transistor T5 receives the enable signal Sn′, and a drain thereof is connected to the first terminal of the storage capacitor 16. The first compensation transistor T4 and the second compensation transistor T5 may be turned on or off under a control of the enable signal Sn′. The first terminal of the storage capacitor 16 is connected to the gate of said driving transistor DTFT, the second terminal thereof is connected to the driving voltage. A gate of the first reset transistor T6 receives the reset signal, a source thereof is connected to the initial voltage Vint, and a drain thereof is connected to a source of the second reset transistor T7 and the first terminal of the organic light emitting diode OLED. A gate of the second reset transistor T7 receives the reset signal, and a drain thereof is connected to the source of the first compensation transistor T4. The first reset transistor T6 and the second reset transistor T7 be turned on or off under a control of the reset signal.

In an exemplary embodiment of the present disclosure, the above reset signal may be a second scan signal Sn−1. The second scan signal Sn−1 is provided by a second scan line, and the second scan line is a previous row of scan line to the first scan line. In this way, the overall amount of control signals and control lines may be reduced.

It should be noted that, although in the above exemplary embodiment, in order to improve the switching speed, the compensation unit includes a first compensation transistor T4 and a second compensation transistor T5, in other exemplary embodiments, the compensation unit may only include one transistor. For example, the compensation unit includes a compensation transistor. In this case, a gate of the compensation transistor receives the enable signal Sn′, a source thereof is connected to the drain of the driving transistor DTFT, and a drain thereof is connected to the first terminal of the storage capacitor 16, and so on.

An additional advantage of the pixel driving circuit of the present embodiment lies in that, each of the transistors is of a single channel type, i.e., a P type thin film transistor. Entirely P type thin film transistors may provide the advantage of, for example, a strong suppression against noise. For example, they are turned on at a low level which may be easily implemented in charging management. For example, an N type thin film transistor is subject influence of ground bounce, while a P type thin film transistor is only subject to influence of IR Drop of the driving voltage line, which generally may be eliminated more easily. For example, for a P type thin film transistor, the production process is simple, and the cost is low. For example, stability of a P type thin film transistor is better than other advantages. Therefore, with entirely P type thin film transistors, not only complexity of the production process and production cost is reduced, but also the product quality may be improved. As illustrated in FIG. 3, in case where each of the transistors are a P type thin film transistor, a source of the second switching transistor T2 is connected to a high level driving voltage ELVDD, a drain of the third switching transistor T3 is connected to an anode of the organic light emitting diode OLED, and a cathode of the organic light emitting diode OLED is connected a low level voltage ELVSS.

However, those skilled in the art would anticipate that the pixel driving circuit provided by the present disclosure may be easily modified into a pixel driving circuit of entirely N type thin film transistors. The structural difference from that of the circuit composed of P type thin film transistors mainly lies in that, in a case where all the transistors are N type thin film transistors, the point corresponding to the source of the second switching transistor T2 is connected to a low level driving voltage, the point corresponding to the drain of the switching transistor T3 is connected to the cathode of the organic light emitting diode OLED, and the anode of the organic light emitting diode OLED is connected to a high level voltage. However, the pixel driving circuit provided by the present disclosure may be easily modified into a CMOS (Complementary Metal Oxide Semiconductor) circuit, and so on, which is not limited to the pixel driving circuit according to the present embodiment and will not be repeated herein.

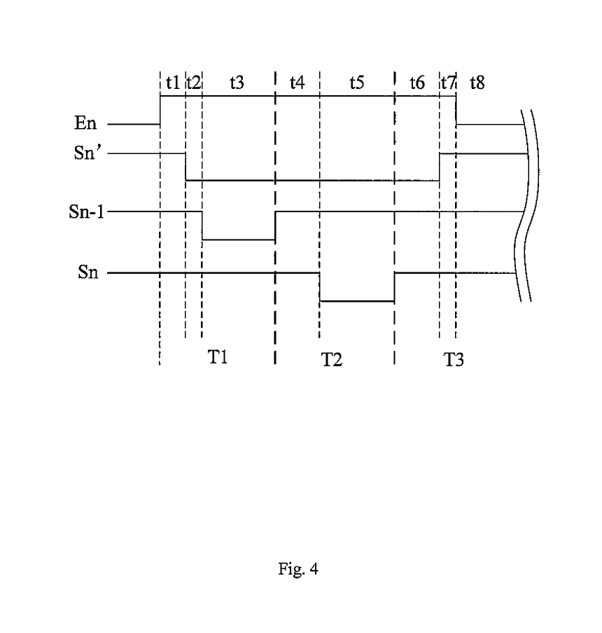

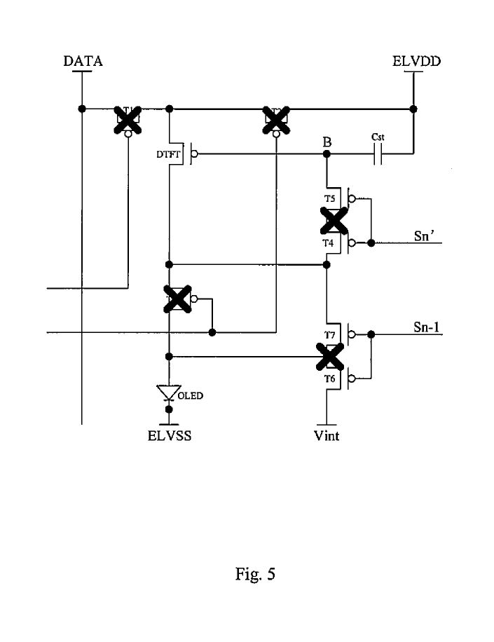

Hereinafter, a driving method of the pixel driving circuit in FIG. 3 will be described by referring to the timing sequence diagram of FIG. 4. As illustrated in FIG. 4, the driving method mainly includes a reset stage T1, a charging stage T2 and a displaying stage T3. In order to avoid input noise due to simultaneous transitions of signals, the reset stage T1 may be divided into timing sections t1-t3, the charging stage T2 may be divided into timing sections t4-t6, and the displaying stage may be divided into timing sections t6-t8. FIGS. 5-12 show equivalent circuits corresponding to the above timing sections.

For example, as illustrated in FIGS. 4 and 5, in the timing section t1 of the reset stage, the first scan signal Sn, the second scan signal Sn−1, the light emitting control signal En and the enable signal Sn′ are at a high level, and all of the transistors are turned off.

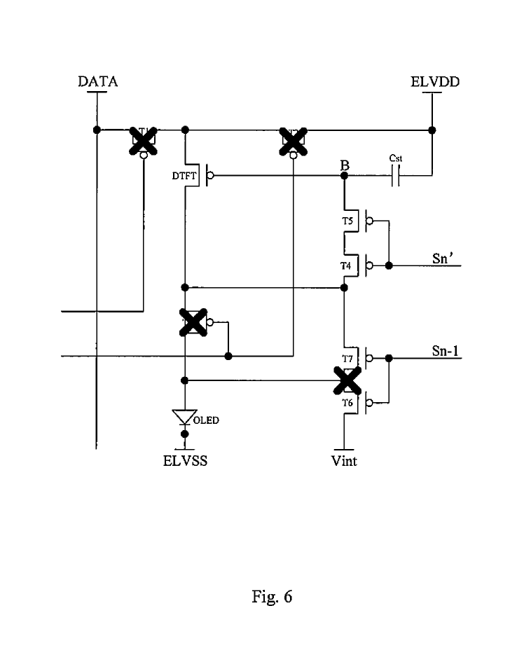

As illustrated in FIGS. 4 and 6, in the timing section t2 of the reset stage, the first scan signal Sn, the second scan signal Sn−1 and the light emitting control signal En are at a high level, and the enable signal Sn′ are at a low level. The first compensation transistor T4 and the second compensation transistor T5 are turned on, and the first switching transistor the second switching transistor T2, the third switching transistor T3, the first reset transistor T6, the second reset transistor T7 are turned off. This timing section is a preparation for the reset in the next timing section.

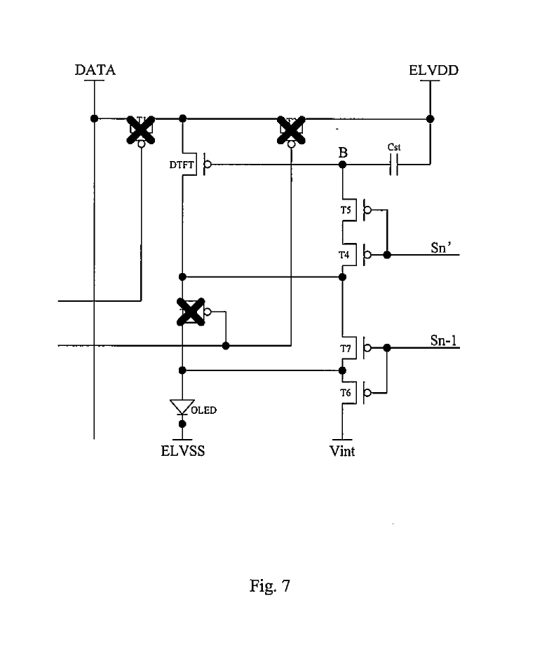

As illustrated in FIGS. 4 and 7, in the timing section t3 of the reset stage, the first scan signal Sn and the light emitting control signal En are at a high level, and the second scan signal Sn−1 and the enable signal Sn′ are at a low level. The first compensation transistor T4, the second compensation transistor T5, the first reset transistor T6 and the second reset transistor T7 are turned on, and the first switching transistor T1, the second switching transistor T2 and the third switching transistor T3 are turned off. In this timing section, the initial voltage Vint is applied to the first terminal of the organic light emitting diode OLED via the first reset transistor T6, to reset the organic light emitting diode OLED. Further, the initial voltage Vint is applied to the first terminal of the storage capacitor 16 via the first reset transistor T6, the second reset transistor T7, the first compensation transistor T4 and the second compensation transistor T5, so that a voltage at the gate of the driving transistor DTFT V_{B}=Vint, so as to eliminate the influence of the residual voltage signal of the previous frame.

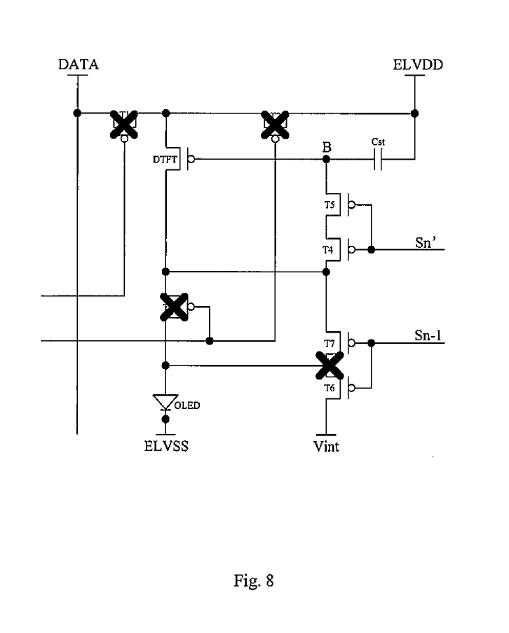

As illustrated in FIGS. 4 and 8, in the timing section t4 of the charging stage, the first scan signal Sn, the second scan signal Sn−1 and the light emitting control signal En are at a high level, and the enable signal Sn′ is at a low level. The first compensation transistor T4 and the second compensation transistor T5 are turned on, and the first switching transistor T1, the second switching transistor T2, the third switching transistor T3, the first reset transistor T6 and the second reset transistor T7 are turned off. In this timing section, the voltage of the gate of the driving transistor DTFT is sustained constant.

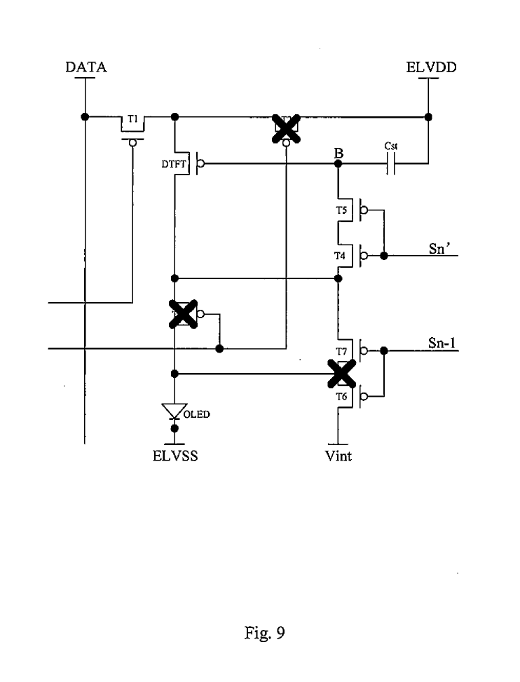

As illustrated in FIGS. 4 and 9, in the timing section t5 of the charging stage, the second scan signal Sn−1 and the light emitting control signal En are at a high level, and the first scan signal Sn and the enable signal Sn′ are at a low level. The first switching transistor T1 and the first compensation transistor T4 and the second compensation transistor T5 are turned on, and the second switching transistor T2, the third switching transistor T3, the first reset transistor T6 and the second reset transistor T7 are turned off. In this timing segment, since the driving transistor DTFT forms a diode connection (i.e., in a saturate state), the data signal Data is written into the storage capacitor 16 via the first switching transistor T1, the diode connection formed by the driving transistor DTFT, the first compensation transistor T4 and the second compensation transistor T5, to charge the storage capacitor 16, so that a voltage at point B rises to Vdata+Vth (Vdata is level of the data signal Data, and Vth is the threshold voltage of the driving transistor DTFT).

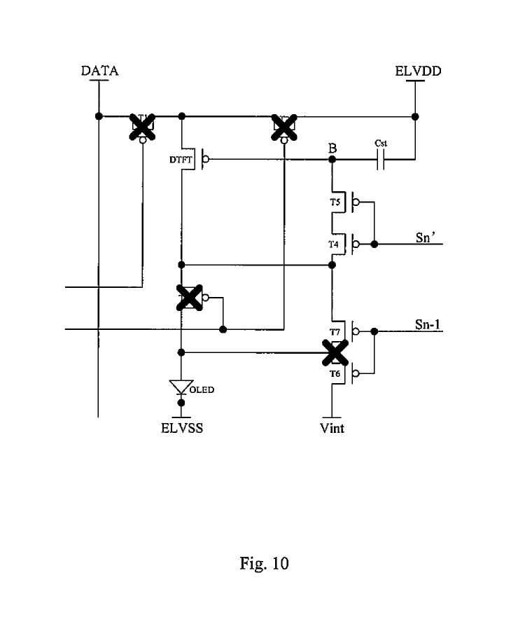

As illustrated in FIGS. 4 and 10, in the timing section t6 of the charging stage, the first scan signal Sn, the second scan signal Sn−1 and the light emitting control signal En are at a high level, and the enable signal Sn′ is at a low level. The first compensation transistor T4 and the second compensation transistor T5 are turned on, and the first switching transistor T1, the second switching transistor T2, the third switching transistor T3, the first reset transistor T6 and the second reset transistor T7 are turned off. In this timing section, the voltage of the gate of the driving transistor DTFT is sustained constant.

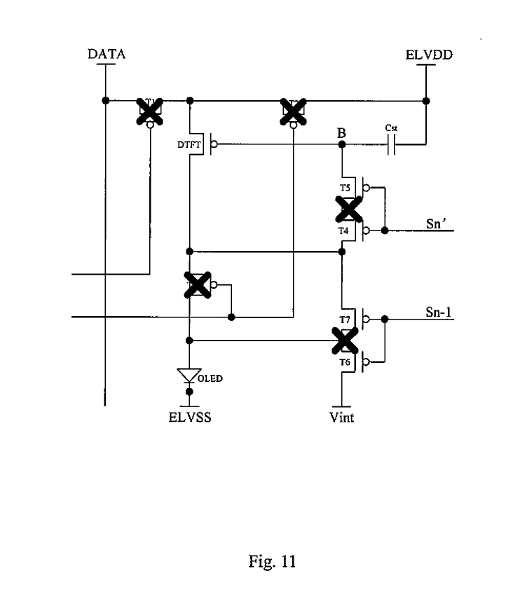

As illustrated in FIGS. 4 and 11, in the timing section t7 of the displaying stage, the first scan signal Sn, the second scan signal Sn−1, the light emitting control signal En and the enable signal Sn′ are at a high level. The first switching transistor T1, the second switching transistor T2, the third switching transistor T3, the first compensation transistor T4, the second compensation transistor T5, the first reset transistor T6 and the second reset transistor T7 are all turned off. In this timing section, the driving transistor DTFT dose not form a diode connection, and the voltage at the gate is sustained constant as Vdata+Vth.

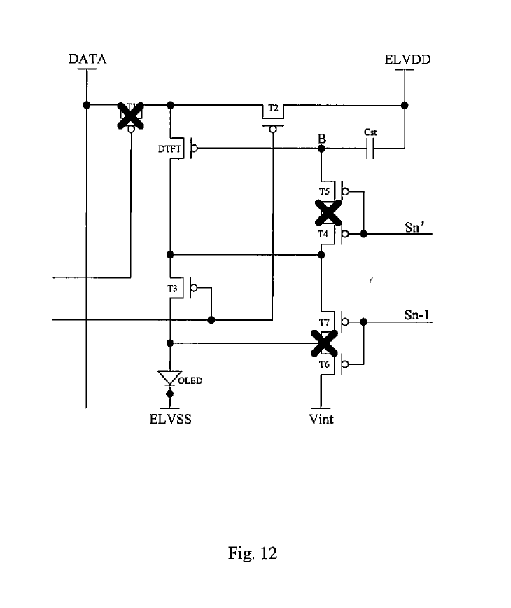

As illustrated in FIGS. 4 and 12, in the timing section t8 of the displaying stage, the first scan signal Sn, the second scan signal Sn−1 and the enable signal Sn′ are at a high level, and the light emitting control signal En is at a low level. The second switching transistor T2 and the third switching transistor T3 are turned on, and the first switching transistor T1, the first compensation transistor T4, the second compensation transistor T5, the first reset transistor T6 and the second reset transistor T7 are turned off. In this timing section, the voltage at the first terminal of the storage capacitor 16, i.e. the gate voltage V_{g} of the driving transistor DTFT is:

V_{g}=Vth+Vdata

If the source voltage of the driving transistor DTFT is Vₛ=ELVDD, a gate-source voltage thereof V_{gs} is:

V_{gs}=V_{g}−Vₛ=Vth+Vdata−ELVDD

At this time, the driving transistor DTFT is in a linear state, and provides a stable driving current to the organic light emitting diode OLED. The driving current of the organic light emitting diode OLED is:

$$\begin{matrix}{I}_{oled} = \frac{1}{2} {μ}_{n} \cdot {C}_{OX} \cdot \frac{W}{L} \cdot {( {V}_{gs} - Vth )}^{2} \\ = \frac{1}{2} {μ}_{n} \cdot {C}_{OX} \cdot \frac{W}{L} \cdot {( Vth + Vdata - ELVDD - Vth )}^{2} \\ = \frac{1}{2} {μ}_{n} \cdot {C}_{OX} \cdot \frac{W}{L} \cdot {( Vdata - ELVDD )}^{2}\end{matrix}$$

Where μₙ·C_{OX}·W/L is a constant relevant to the production process and design. Finally, the driving current passes through the third switching transistor T3 to drive the organic light emitting diode OLED to emit light.

It can be seen from the above that, in the present exemplary embodiment, since the driving current is irrelevant to the threshold voltage Vth of the driving transistor DTFT, the drift of the threshold voltage of the driving transistor DTFT will not influence the drain current, i.e. a driving current I_{oled} of the organic light emitting diode OLED. Accordingly, in the present exemplary embodiment, by effectively compensating for the drift of the threshold voltage, the uniformity and stability of the driving currents may be ensured, and thus the brightness of the OLED display panel may be made more uniform.

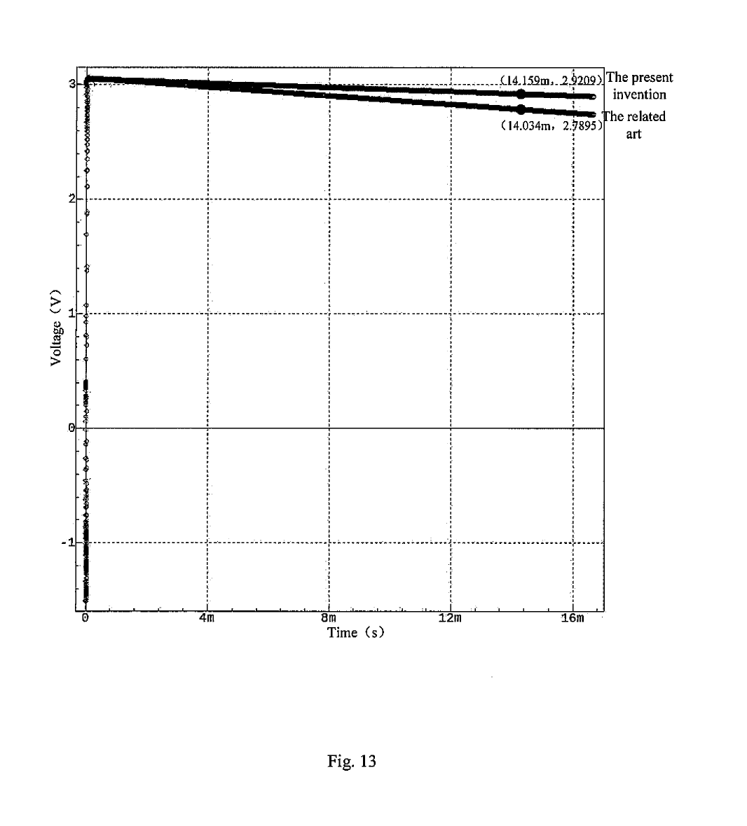

Further, since in the present exemplary embodiment, a path for the leakage current of the storage capacitor is only via the compensation unit, while in the related art, the pixel driving circuit with a compensation function for the threshold voltage generally have more paths for the leakage current, the pixel driving circuit according to the present exemplary embodiment has another technical effect of reducing the leakage current of the storage capacitor. For example, as illustrated in FIG. 13, a simulation result of the pixel driving circuit according to the present exemplary embodiment shows, the leakage current of the storage capacitor of the pixel driving circuit according to the present exemplary embodiment is significantly small. In this way, the pixel driving circuit according to the present exemplary embodiment may also improve the stability of the gate voltage of the driving transistor supplied by the storage capacitor, thus further improve the uniformity and contrast of the displayed screen, and make the black screen more stable.

Further, the present exemplary embodiment also provides a display device. The display device includes a plurality of data lines for providing data signals; a plurality of scan lines for supplying scan signals; and a plurality of pixel driving circuits, electrically connected to the data lines and the scan lines. Each of the pixel driving circuits may be any of the pixel driving circuits according to the present exemplary embodiment described above. Since in the pixel driving circuits, the drift of the threshold voltage of the driving transistor is compensated, the organic light emitting diode may display stably, the uniformity of the brightness of the display device may be improved, and thus the display quality may be significantly improved.

Although the present disclosure has been described with reference to the above relevant embodiments, they are only exemplary. It should be noted that, the scope of the present disclosure are not limited within the disclosed embodiments. Rather, various variations and modifications made without departing from the spirit and scope of the present disclosure all fall into the protection scope of the present disclosure.

What is claimed is:

1. A pixel driving circuit, comprising:
an organic light emitting diode;
a storage capacitor;
a driving transistor;
a compensation unit configured to write a threshold voltage of the driving transistor into the storage capacitor in response to an enable signal;
a first switching transistor configured to write a data signal into the storage capacitor via the driving transistor and the compensation unit in response to a first scan signal;
a second switching transistor configured to apply a driving voltage to the driving transistor in response to a light emitting control signal;
a third switching transistor configured to apply a driving current output from the driving transistor to the organic light emitting diode to cause it to emit light, in response to the light emitting control signal; and
a reset unit is configured to reset the organic light emitting diode and the storage capacitor with an initial voltage, in response to a reset signal,
wherein the storage capacitor is configured to store the written data signal and the threshold voltage and apply the written data signal and the threshold voltage to a gate of the driving transistor.

2. The pixel driving circuit according to claim 1, wherein:
the first switching transistor has a gate that receives the first scan signal, a source that receives the data signal, and a drain that is connected to a source of the driving transistor;
the second switching transistor has a gate that receives the light emitting control signal, a source that is connected to the driving voltage, and a drain that is connected to a source of the driving transistor;
the third switching transistor has a gate that receives the light emitting control signal, a source that is connected to a drain of the driving transistor, and a drain that is connected to a first terminal of the organic light emitting diode;
the compensation unit has a first terminal that is connected to the drain of the driving transistor, a second terminal that is connected to the storage capacitor, and a control terminal that receives the enable signal;
the storage capacitor has a first terminal that is connected to the gate of the driving transistor, and a second terminal that is connected to the driving voltage; and
the reset unit has a first terminal that is connected to the initial voltage, a second terminal that is connected to the first terminal of the organic light emitting diode, a third terminal that is connected with the first terminal of the compensation unit, and a control terminal that receives the reset signal.

3. The pixel driving circuit according to claim 2, wherein:
the reset unit comprises a first reset transistor and a second reset transistor;
the first reset transistor has a gate that receives the reset signal, a source that is connected to the initial voltage, and a drain that is connected to a source of the second reset transistor and the first terminal of the organic light emitting diode; and
the second reset transistor has a gate that receives the reset signal, and a drain that is connected to the first terminal of the compensation unit.

4. The pixel driving circuit according to claim 2, wherein:
the compensation unit comprises a first compensation transistor and a second compensation transistor;
the first compensation transistor has a gate that receives the enable signal, a source that is connected to the drain of the driving transistor, and a drain that is connected to a source of the second compensation transistor; and
the second compensation transistor has a gate that receives the enable signal, and a drain that is connected to the first terminal of the storage capacitor.

5. The pixel driving circuit according to claim 2, wherein:
the reset signal is a second scan signal;
the first scan signal is provided by a scan line; and
the second scan signal is provided by a previous scan line to the scan line.

6. The pixel driving circuit according to claim 3, wherein:
all of the transistors are P type thin film transistors;
the driving voltage connected to the source of the second switching transistor is a high level driving voltage;
the drain of the third switching transistor is connected to an anode of the organic light emitting diode; and
the organic light emitting diode has a cathode that is connected to a low level voltage.

7. The pixel driving circuit according to claim 3, wherein:
all of the transistors is an N type thin film transistor;
the driving voltage connected to the source of the second switching transistor is a low level driving voltage;
the drain of the third switching transistor is connected to a cathode of the organic light emitting diode; and
the organic light emitting diode has an anode that is connected to a high level voltage.

8. A method for driving a pixel driving circuit according to claim 1, and the driving method comprises:
turning on the compensation unit and the reset unit respectively by using the enable signal and the reset signal, thereby causing the initial voltage to reset the organic light emitting diode via the reset unit and to reset the storage capacitor via the reset unit and the compensation unit respectively;
turning on the first switching transistor and the compensation unit respectively by using the first scan signal and the enable signal, thereby causing the data signal and the threshold voltage to be written into the storage capacitor; and
turning on the second and the third switching transistor by using the light emitting control signal, thereby turning on the driving transistor by using the data signal and the threshold voltage written into the storage capacitor, and causing the driving voltage drive to drive the organic light emitting diode to emit light via the second and the third switching transistor and the driving transistor.

9. A display device, comprising:
a plurality of data lines that provides data signals;
a plurality of scan lines that supplies scan signals comprising a first scan signal and a second scan signal which are provided successively; and
a plurality of pixel driving circuits, electrically connected to the data lines and the scan lines, each of the plurality of pixel driving circuit comprising:
an organic light emitting diode;
a storage capacitor;
a driving transistor;
a compensation unit configured to write a threshold voltage of the driving transistor into the storage capacitor in response to an enable signal;
a first switching transistor configured to write a data signal into the storage capacitor via the driving transistor and the compensation unit in response to a first scan signal;
a second switching transistor configured to apply a driving voltage to the driving transistor in response to a light emitting control signal;
a third switching transistor configured to apply a driving current output from the driving transistor to the organic light emitting diode to cause it to emit light, in response to the light emitting control signal; and
a reset unit is configured to reset the organic light emitting diode and the storage capacitor with an initial voltage, in response to a reset signal,
wherein the storage capacitor is configured to store the written data signal and the threshold voltage and apply the written data signal and the threshold voltage to a gate of the driving transistor.

10. The display device according to claim 9, wherein:
the first switching transistor has a gate that receives the first scan signal, a source that receives the one data signal, and a drain that is connected to a source of the driving transistor;
the second switching transistor has a gate that receives the light emitting control signal, a source that is connected to the driving voltage, and a drain that is connected to a source of the driving transistor;
the third switching transistor has a gate that receives the light emitting control signal, a source that is connected to a drain of the driving transistor, and a drain that is connected to a first terminal of the organic light emitting diode;
the compensation unit has a first terminal that is connected to the drain of the driving transistor, a second terminal that is connected to the storage capacitor, and a control terminal that receives the enable signal;
the storage capacitor has a first terminal that is connected to the gate of the driving transistor, and a second terminal that is connected to the driving voltage; and
the reset unit has a first terminal that is connected to the initial voltage, a second terminal that is connected to the first terminal of the organic light emitting diode, a third terminal that is connected with the first terminal of the compensation unit, and a control terminal that receives the reset signal.

11. The pixel driving circuit according to claim 10, wherein:
the reset unit comprises a first reset transistor and a second reset transistor;
the first reset transistor has a gate that receives the reset signal, a source that is connected to the initial voltage, and a drain that is connected to a source of the second reset transistor and the first terminal of the organic light emitting diode; and
the second reset transistor has a gate that receives the reset signal, and a drain that is connected to the first terminal of the compensation unit.

12. The pixel driving circuit according to claim 10, wherein:
the compensation unit comprises a first compensation transistor and a second compensation transistor;
the first compensation transistor has a gate that receives the enable signal, a source that is connected to the drain of the driving transistor, and a drain that is connected to a source of the second compensation transistor; and
the second compensation transistor has a gate that receives the enable signal, and a drain that is connected to the first terminal of the storage capacitor.

13. The pixel driving circuit according to claim 10, wherein:
the reset signal is the second scan signal;
the first scan signal is provided by one scan line of the plurality of scan lines; and
the second scan signal is provided by a previous scan line to the one scan line.

14. The pixel driving circuit according to claim 11, wherein:
all of the transistors are P type thin film transistors;
the driving voltage connected to the source of the second switching transistor is a high level driving voltage;
the drain of the third switching transistor is connected to an anode of the organic light emitting diode; and
the organic light emitting diode has a cathode that is connected to a low level voltage.

15. The pixel driving circuit according to claim 11, wherein:
all of the transistors is an N type thin film transistor;
the driving voltage connected to the source of the second switching transistor is a low level driving voltage;
the drain of the third switching transistor is connected to a cathode of the organic light emitting diode; and
the organic light emitting diode has an anode that is connected to a high level voltage.
